(19) United States
(12) Patent Application Publication
(10) Pub. No.: US 2022/0090735 A1
(43) Pub. Date: Mar. 24, 2022

(54) Hand Held Mount

(71) Applicant: Jeffry C. Voorhees, Lafayette, CA (US)

(72) Inventor: Jeffry C. Voorhees, Lafayette, CA (US)

(21) Appl. No.: 17/479,768

(22) Filed: Sep. 20, 2021

Related U.S. Application Data
(60) Provisional application No. 63/081,040, filed on Sep. 21, 2020.

(51) Int. Cl. F16M 13/02; F16M 13/04

(52) U.S. Cl. CPC F16M 13/022; F16M 13/04

(57) ABSTRACT

The present disclosure describes a handheld mount for a tablet, the mount comprising a grip cup configured to be releasably attached to a vessel and is graspable by a hand of a user, resilient straps attached to the grip cup, and attachment members arranged at ends of the resilient straps, the attachment members configured to releasably attach the resilient straps and the grip cup to the tablet.

### CROSS REFERENCE TO RELATED APPLICATIONS

This application claims the benefit of U.S. Provisional Application No. 63/081,040, filed on Sep. 21, 2020, the entire contents of which are incorporated by reference herein.

### TECHNICAL FIELD

This disclosure relates to handheld mounts for a tablet.

### BACKGROUND

Tablets are being employed for various activities, such as streaming entertainment or surfing the internet. Furthermore, tablets are often mounted in a fixed position to visually monitor current events, texting, emails and social media. For example, audio engineers and film crew electricians can utilize tablets in their industries, and they have the ability to walk around and control their boards though a wireless routing system. Additionally, helping with the operation of household chores that has become a standard feature for electronic devices. The creation of the stylus working with tablets has given the freedom to interact in a non-digital format. Presentations and sharing information are becoming more interactive by gripping the device with just one hand. In addition, voice activation has become more of daily tool, making it necessary to verbally interact with the media player.

### SUMMARY

In an aspect, a mount for a tablet includes a grip cup releasably attached to a vessel and is graspable by a hand of a user, resilient straps attached to the grip cup, and attachment members arranged at ends of the resilient straps, the attachment members releasably attach the resilient straps and the grip cup to the tablet.

Embodiments can include one or more of the following features.

The attachment members hold the tablet at corners of the tablet.

The grip cup is circular in shape.

The grip cup defines a connecting aperture, the aperture being located along a longitudinal axis of the grip cup.

The grip cup comprises plastic.

The attachment members are adjustable to accommodate different size tablets.

One of the attachment members is a different color than the other attachment members to indicate a proper orientation of the mount relative to the tablet.

In an aspect, a system for holding a tablet includes a mount including a grip cup releasably attached to a vessel and graspable by a hand of a user, resilient straps attached to the grip cup, and attachment members arranged at ends of the resilient straps, the attachment members releasably attach the resilient straps and the grip cup to the tablet, and a connecting vessel configured to hold the mount.

Embodiments can include one or more of the following features.

The connecting vessel is configured to hold the mount by the grip cup.

The grip cup defines a connecting aperture, the aperture being located along a longitudinal axis of the grip cup.

The connecting vessel comprises a threaded connector.

The threaded connector is loose and pliable.

The connecting aperture is inserted directly on to the threaded connector.

The threaded connector acts as a locking mechanism.

The system includes a wing nut screwed onto the threaded connector to mount the grip cup to the connecting vessel in a locked position.

The mount and the connecting vessel are configured so that the mount can be disconnected from the connecting vessel by pulling the grip cup along the longitudinal axis of the grip cup.

The connecting vessel further comprises installing apertures.

The attachment members are adjustable to accommodate different size tablets.

The attachment members are configured to hold the tablet at corners of the tablet.

The grip cup and the connecting vessel are circular in shape.

Embodiments can include one or more of the following advantages.

A tablet holder can be used to keep the tablet mounted in a fixed position for hands free accessibility. It can be advantageous for consumers to have the tablet mounted in a position in which the screen is visible without the consumer needing to hold the tablet up with their hands.

Additionally, the natural position for operating a tablet device is hand held. The thin frame of the device makes it unmanageable and awkward to grip with only one hand. Mild fatigue from holding as well as the heat built up from a hot electronic device can make the overall task uncomfortable on the hands, especially for individuals suffering from arthritis or other such conditions and handicaps that make it difficult to hold objects for extended periods of time. Tendonitis in many instances makes it difficult for individuals with limited hand mobility to communicate via tablet technology. The systems disclosed herein can allow consumers to more easily hold a tablet or mount a tablet. The disclosed systems can also advantageously allow mounting and holding in one motion so that it is no longer cumbersome to go from holding the tablet to mounting the tablet securely. Simple tasks such as drinking coffee while holding a tablet and mounting it securely with one hand are possible with the systems described herein.

The mounts disclosed herein are not limited to mounting tablets. Such mounts can also attach to other types of devices, e.g., service trays, clipboards, binders, plastic hardware cases, and RC controllers for drones.

### DESCRIPTION OF DRAWINGS

FIGS. 1A-C illustrate components of a mounting system.

FIG. 2 illustrates a hand held mount of the type illustrated in FIG. 1A being held and attached to a tablet.

FIGS. 3A and 3B illustrate front and rear views, respectively, of a hand held mount of the type illustrated in FIG. 1B.

FIGS. 4A and 4B illustrate front and rear views, respectively, of a hand held mount of the type illustrated in FIG. 1A.

FIGS. 5A-D illustrate side views of a hand held mount of the type illustrated in FIG. 1A.

FIG. 6A illustrates a connecting vessel of the type illustrated in FIG. 1C.

FIGS. 6B and 6C illustrate a wing nut that can be used to secure a grip cup to the connecting vessel of FIG. 6A.

FIGS. 7A-C illustrate different views of the connecting vessel of FIG. 6A.

FIGS. 8A and 8B illustrate exemplary environments in which a connecting vessel can be used.

FIG. 9 illustrates a different base option for a connecting vessel.

FIGS. 10A and 10B illustrate a hand held mount mounted to a tablet case.

FIGS. 11A and 11B illustrate an assembly including a connecting vessel extending from a base.

FIG. 11C illustrates a hand held mount of the type illustrated in FIG. 1B, releasably attached to a tablet.

FIG. 11D illustrates the hand held mount of FIG. 11C stowed in a carrying case.

FIG. 12 illustrates a tablet mounted on a mounting system.

### DETAILED DESCRIPTION

In certain aspects of the disclosure, a mounting system includes a round cup on the opposite side of the apparatus that makes it easy to grip a device with just one hand. The flat surface can, for example, be mounted to a tablet and the round can be grasped by the user to hold the tablet in a desired orientations.

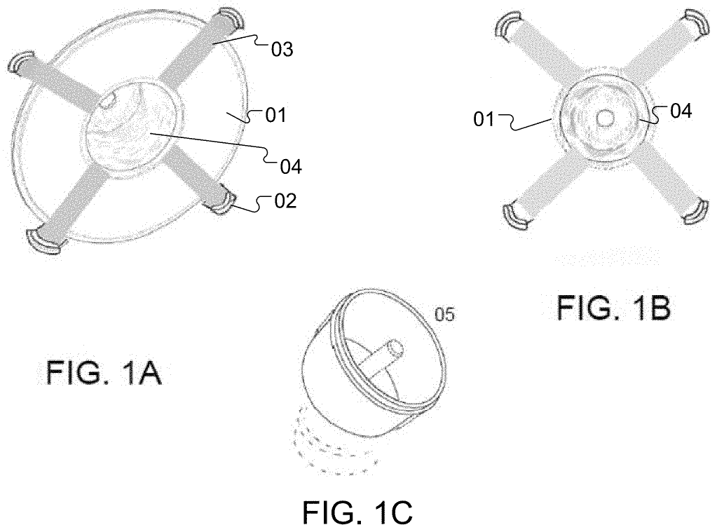

Referring to FIG. 1A, a hand held vessel mount system provides a main apparatus 01 (e.g., a flat surface) with a grip cup 04. The main apparatus 01 can be releasably attached to a flat surface of a tablet. The material of the surface can be any material or fastener that will serve as a point of attachment for the relative object. Additionally, the main apparatus 01 can include resilient straps 03 attached to the main apparatus 01. The resilient straps 03 can include attachment members 02 at the ends of the resilient straps 03 to grip corners of the tablet. The main function of the resilient straps 03 is to secure different sized tablets (e.g., on the market today or in the future) in a cost effective manner due to their resilient properties.

The attachment members 02 are closed plastic rings with a curved end that can be placed on the corners of a tablet to hold the resilient straps and the grip cup 04 to the tablet. The attachment members 02 are attached to the resilient straps 03. The attachment members 02 can be made of plastic and could be form fitted, or can be made of a more pliable material, such as rubber, and stretch across the corners of the tablet to secure the device. Options for larger attachment members 02 can also be employed for tablets with protective cases. The attachment members 02 are specific to the corners of the tablet and can be put in position by sliding them along the sides of a tablet to the corners, after hooking them loosely on the side of the device. However, the described form of the attachment members 02 is not limiting and the attachment members 02 can take other forms.

Referring to FIG. 1B, another embodiment of a hand held mount system is illustrated that is similar to the system of FIG. 1A. However, in this implementation, a large flat surface is not used, and therefore the diameter of the main apparatus 01 is substantially the same as the diameter of the grip cup 04.

Referring to FIG. 1C, a connecting vessel 05 is illustrated to hold the grip cup 04 of any of the aforementioned embodiments. The grip cup 04 of any of the aforementioned embodiments may be fitted into the connecting vessel 05, which can be positioned in a variety of locations for mounting within view of the user. The grip cup 04 lifts in and out of the connecting vessel 05 with little to no effort. And because both parts are round, a tablet which is mounted on the system can spin on its axis from portrait to landscape viewing positions. This system allows the user to go from holding the tablet via the grip cup 04 to mounting the tablet on the connecting vessel 05 with no extra fastening involved (i.e., a ‘1 Step Method’).

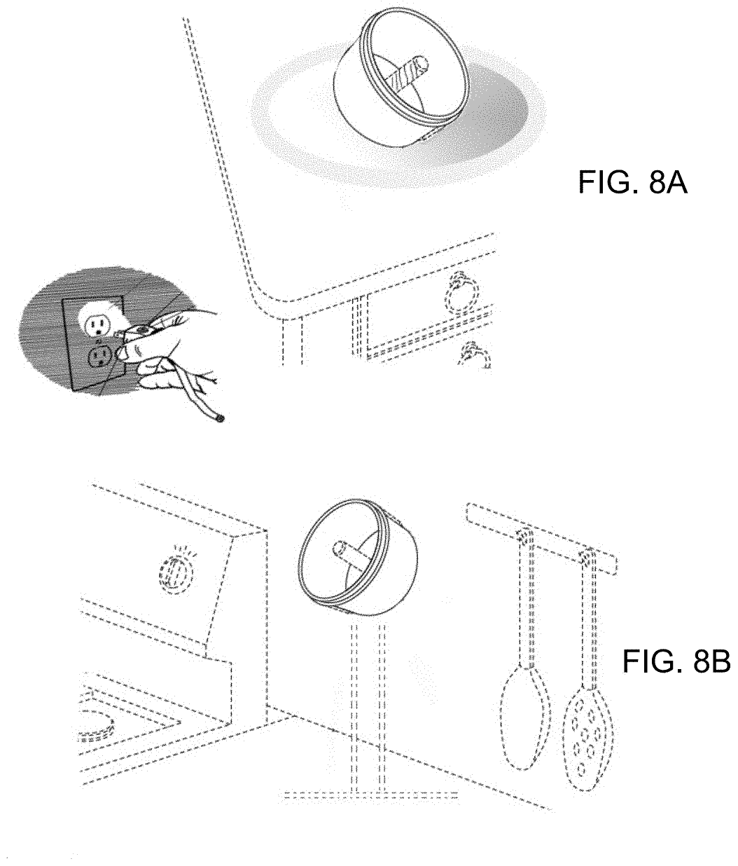

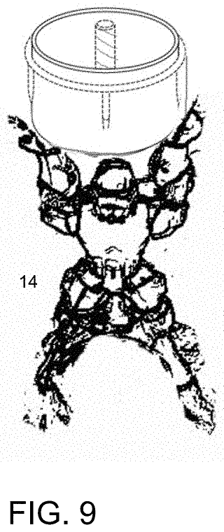

The term “Position of Function” is a medical term used to describe the natural position of the hand at rest. The above-described systems allow a user to ergonomically hold the tablet in a manner that allows the user to hold the tablet in the “Position of Function” (i.e., by holding the tablet by the grip cup 04), helping to alleviate or prevent discomfort while using the tablet. Also, the system provides the freedom to express presentations by allowing the freedom to share ideas without holding the tablet being in awkward positions. In addition, the tablet can be mounted in a variety of situations using just the vessel for convenient viewing and monitoring. The vessel can attach to a variety of surfaces in almost any environment that is practical. The main apparatus 01 and the connecting vessel 05 can be lightweight and low profile. A base (examples shown in FIGS. 8A, 8B, and 9 below) of the connecting vessel 05 can be placed on any table securely, within reach, and in direct view.

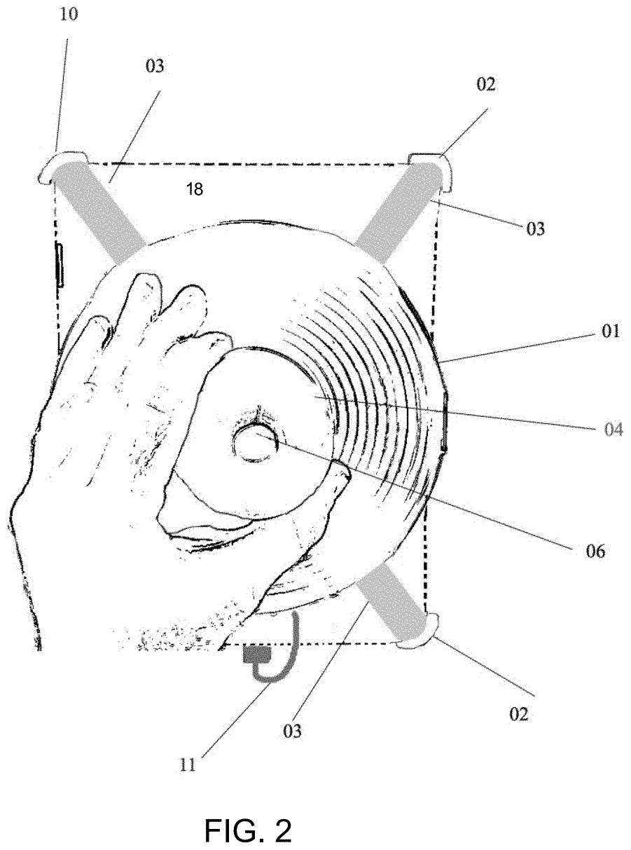

Referring to FIG. 2, a tablet 18 is secured to the hand held mount of FIG. 1A (i.e., a main apparatus 01 with elastic webbing (also referred to herein as resilient straps) 03). The corners of the tablet 18 are slipped into the fitted slots 02 (also referred to herein as attachment members or clips) for holding and securing the device to the main apparatus 01 or grip cup 04. The elastic webbing 03 can be attached to both the grip cup 04 and the fitted slots 02 for holding the tablet 18 securely. One of the fitted slots 10 is a different color as a visual cue and reference to where a control function is located, such as a power switch or volume. The fitted slot 10 that is a different color can therefore indicate a proper orientation of the mount relative to the tablet 18. In addition, the fitted slots 02 may be adjustable to accommodate different size tablet cases. Because of the elastic properties in the webbing 03, the grip cup 04 is able to fit a variety of tablet brands and sizes.

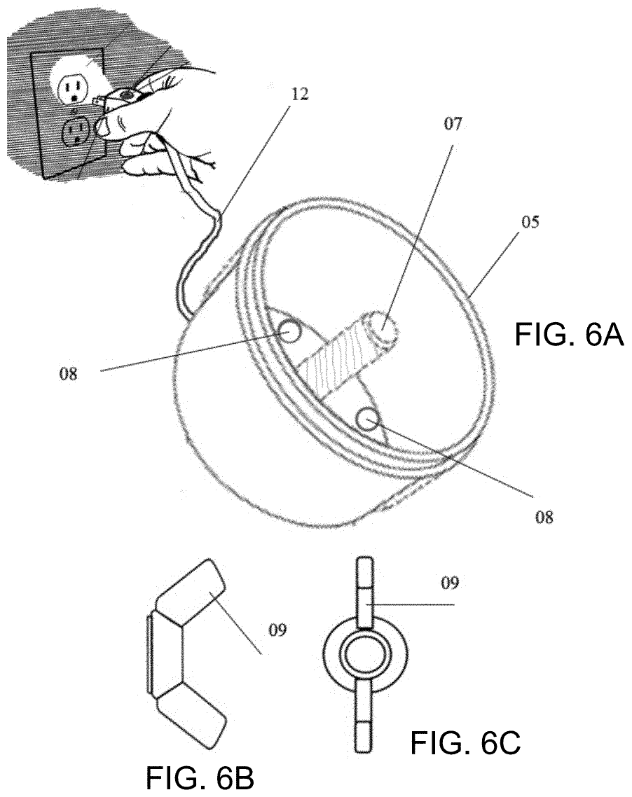

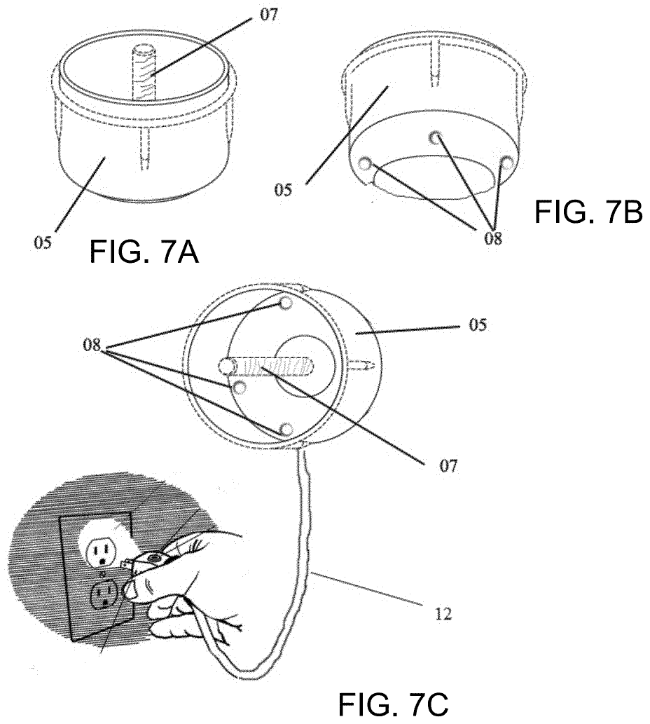

The grip cup 04 is circular in shape and has a connecting aperture 06 located on the top portion (in the orientation shown in FIG. 2) that can be inserted into the connecting vessel 05 (shown in FIG. 6A), which has a slightly larger circumference than the grip cup 04. The connecting vessel 05 is configured for receiving the grip cup 04. Referring to FIG. 6A, the connecting vessel 05 includes a threaded connector 07. When the grip cup 04 is positioned over the connecting hub 05, the connecting aperture 06 on the grip cup 04 is inserted directly onto the threaded connector 07.

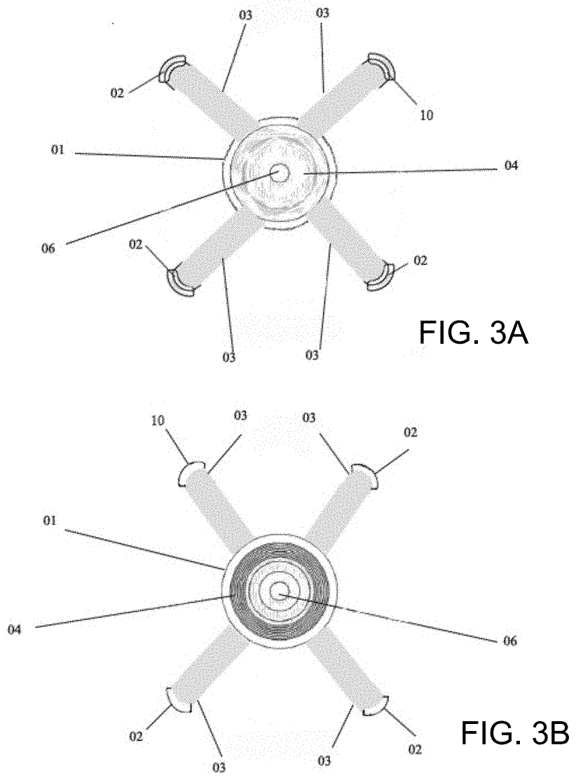

Referring to FIGS. 3A and 3B, front and rear views of a hand held mount of the type shown in FIG. 1B are illustrated. In this embodiment, the main apparatus 01 has about the same diameter as the grip cup 04 because a large surface is not used to attach the grip cup 04 to the tablet 18.

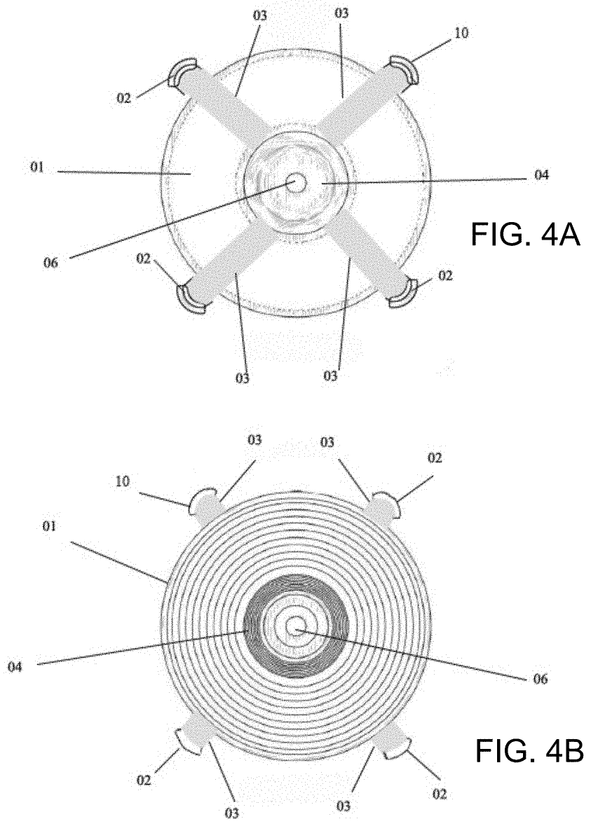

Referring to FIGS. 4A and 4B, front and rear views of a hand held mount of the type shown in FIG. 1B are illustrated. In this embodiment, the main apparatus 01 has a larger diameter than the grip cup 04 to provide a large surface for added stability.

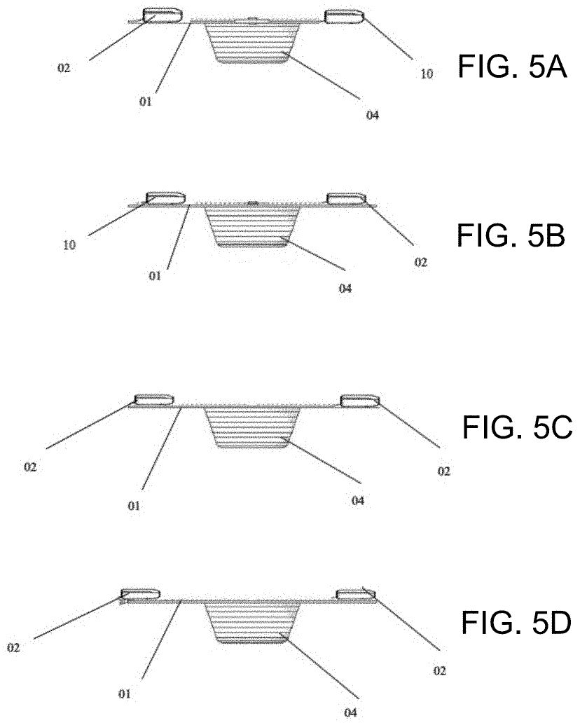

Referring to FIGS. 5A-D, side views of an embodiment of a grip cup 04, elastic webbing 03, and fitted slots 02 are illustrated. The main apparatus 01, in this embodiment, is substantially flat from a side view, and the grip cup 04 extrudes perpendicularly from the main apparatus 01. In FIG. 5A, the differently colored fitted slot 10 is illustrated on the right side. In FIG. 5B, the differently colored fitted slot 10 is illustrated on the left side. In FIGS. 5C and 5D, the differently colored fitted slot 10 is not illustrated because it would be behind the other fitted slots 02. These different views illustrate how the differently colored fitted slot 10 can be used to indicate proper positioning of the mount relative to the tablet.

FIGS. 6A-C and 7A-C illustrate the connecting vessel 05 which can hold the grip cup 04 of any of the aforementioned embodiments. A wing nut 09 (illustrated in FIGS. 6B and 6C) can be screwed onto the threaded connector 07 while the grip cup 04 is mounted in the connecting vessel 05, thereby placing the apparatus into a locked position of being mounted. It is also suggested that the connecting vessel 05 is placed at an angle to allow the above steps to take place.

An advantage of using this device is that the tablet can be placed in a position safe from being knocked over. For example, the connecting vessel 05 can be fastened to a variety of devices and surfaces by employing the installing apertures 08. For example, machine screws or bolts can be screwed through the installing apertures 08 to fasten the connecting vessel 05 to a surface. The installing apertures 08 illustrate a style of mounting available for the connecting vessel 05 in a fixed position and are not bound to any particular position or size. For example, the connecting vessel 05 can also directly mount onto a wall.

As shown in FIGS. 8A and 8B, the connecting vessel 05 can be mounted in a variety of different environments. By using the installing aperture 08, the connecting vessel 05 can be placed in an assortment of locations and with a variety of assemblage of objects and surfaces for the grip cup 04. It should also be mentioned that the holes from the connecting aperture 06 and installing apertures 08 can also be used as passage for a charging cord. In addition, various items can be attached to the bottom of the main apparatus 01 such as a stylus, GoPro Clip, extra battery or charging accessories. Additionally, the connecting vessel 05 is not limited to just one type of base. For example, referring to FIG. 9, the connecting vessel 05 can be mounted to a variety of bases 14. Other entities and categories, such as furniture and ornamentations, are just a few examples of the different types of objects to which the connecting vessel 05 can be mounted.

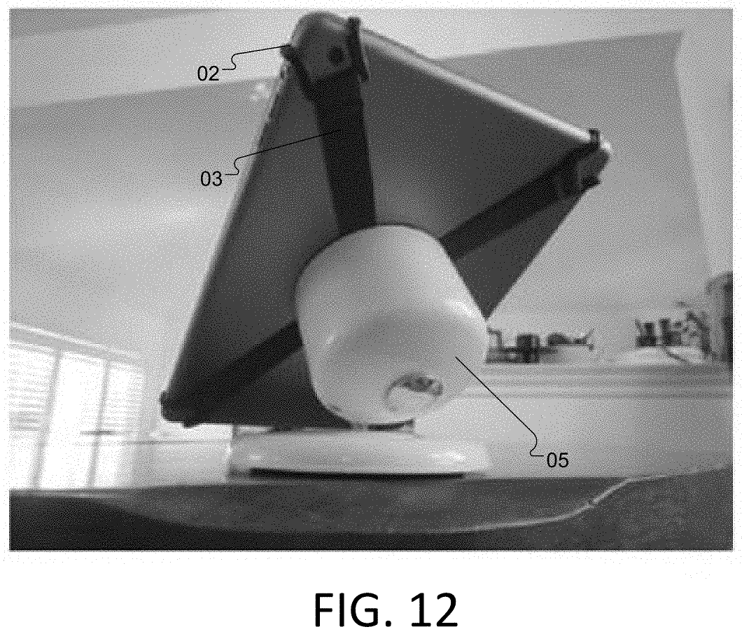

Referring to FIG. 12, a tablet 18 is shown mounted to a type of mount system disclosed herein. In the illustrated examples, the grip cup is placed in the connecting vessel 05. Once placed in the final resting position in the connecting hub 05, the grip cup will not come out of the connecting hub 05 unless it's lifted directly outwards from the connecting vessel 05, and will not come out if lifted at an angle other than perpendicularly (i.e., along the longitudinal axis of the vessel 05). The threaded connector acts as a locking mechanism by creating resistance against any incorrect lifting angles of the grip cup in relationship to the circular connecting shapes of the grip cup, connecting hub 05, threaded connector, and connecting aperture. That is, the grip cup cannot easily slip off or be pulled off the connecting hub unless the grip cup is pulled straight outwardly off the threaded connector, receiving less resistance from the threaded surface biting the connecting aperture. Further resistance can be enabled by making the threaded connector loose and pliable while still being fixed to the connecting hub. By calibrating the threaded connector at an angle, the teeth from the threaded connector bite in to the connecting aperture at a stronger degree of intensity. Because the threaded connector is loose, there is a stronger bond between the connecting hub 05 and the grip cup fastening via the connecting aperture. This action is similar to plugging in to a socket (i.e., charging feature). When the grip cup is plugged into the connecting vessel, the loose threaded connector is guided in to the connecting aperture by pushing the grip cup into the connecting hub 05. A design element can include an outward flange around the connecting hub 05 to make it more accommodating for the grip cup.

In FIG. 12, a mount of the embodiment of FIG. 1B is illustrated mounting a tablet 18 to the connecting vessel 05. The main apparatus in this embodiment does not have a large surface (e.g., the main apparatus has substantially the same diameter as the grip cup and is therefore covered by the connecting vessel 05) and the main apparatus includes elastic webbing 03 and fitted slots 02 to grip the tablet 18.

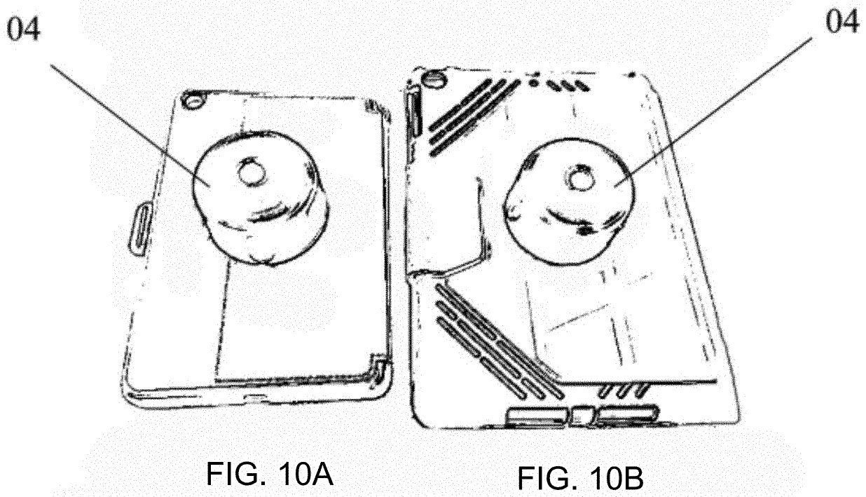

Other methods for attaching multiple devices are also provided. For example, adhesives and/or other fastening methods can be used on the surface side of the main apparatus 01 to attach articles such as tablet cases, phone cases, clipboards, service trays, dinner plates, etc. The main apparatus 01 can be applied in various shapes that is aesthetically pleasing. These examples are not limited to just these articles discussed exclusively, and anything could qualify for an article in the proper environment. Tablet cases now play a large part in the mounting system and can potentially be branded by the company(s) employing it. For example, referring to FIGS. 10A and 10B, a tablet case can be manufactured with a grip cup 04 integral with the tablet case. The grip cup 04 can then be placed into the connecting vessel 05 as described herein to mount the tablet.

In some embodiments, a thin groove could be sliced in the main apparatus 01 that accepts a male side which may be manufactured on products such as tablet cases, phone cases, clip boards, service trays, dinner plates, etc. When applied, the male side of one of these products are inserted in the groove of the main apparatus 01 and can turn in a clockwise motion, locking the two items together. The process can be reversed to separate the two items.

Accessories to complement the main apparatus 01 might include a fastening device that attaches to a user's leg for stabilizing activities while sitting, including but not limited to reading, playing a game, or entering data. The attachment can be located at the connecting aperture 06, where an adaptor can be attached for a more stable fastening device in this embodiment.

It should be mentioned that for illustration purposes there are two features that perform the same duty. The main apparatus 01 and grip cup 04 are integral and can be the same, and can be used with or without the presence of the connecting vessel 05.

In some embodiments, the present systems can include charging features and voice commands. For example, the connecting vessel 05 can be a charging base, and the threaded connector 07 can be a charging stem.

Referring again to FIG. 2, the charging cable 11 from the tablet is plugged into the grip cup 04. When the grip cup 04 comes in contact with the threaded connector charging stem 07, (i.e., when the grip cup 04 is mounted on the connecting vessel charging base 05) a charge of electricity is facilitated though the connecting aperture 06 from the connecting vessel charging base 05 through a charging cable from a power source 12 (as shown in FIG. 6A). When the user picks up the tablet from the connecting vessel charging base 05, the tablet is no longer in position to receive a charge of electricity.

In some embodiments, once the tablet is securely in the connecting vessel charging base 05, a voice activation feature is enabled, helping to save battery life. From a hand held position, upon completion of a task, the grip cup 04 with a charging cable 11 attached is placed in the connecting vessel charging base 05, making physical contact with the threaded connector charging stem 07 through the connecting aperture 06, which in turn connects the tablet to a power source 12. In this position, charging of the tablet occurs and voice controls are enabled.

The present systems can be manufactured by plastic mold injection. The main apparatus 01, grip cup 04, and connecting vessel 05 are parts that could be made from molded plastic. Also available are various cups/caps from plastic parts which are already manufactured. Once the parts have been molded, the adjustable fitted slots 02 (clips), elastic webbing 03, and the threaded connecting connector 07 (and electric rigging) will generally be manufactured on a secondary schedule. The elastic webbing 03 can be fastened on to the main apparatus 01 or grip cup 04 after the molding process in many different methods. It can also be mentioned that in place of the threaded connecting bolt charging connector 07 (charging feature), a retractable cord power cord can be installed or a power cord supplied by the user can also be used, cutting down on manufacturing cost.

Different color choices and materials also play a role in the overall style and presentation for the main apparatus 01, elastic webbing 03, grip cup 04, and connecting vessel 05. For example, the main apparatus 01 can include an indicator light that turns on while a tablet is charging, lighting up the entire main apparatus 01, which may be manufactured, e.g., from a transparent ABS. Rubber and other materials may play a part in the hand held feature of this system. Also, the decorative flavor can be something that distinguishes the hand held system.

This system reflects the ‘One Step Method’ for mounting and unmounting an electronic or non-electronic device by employing a connecting vessel 05 and a base 14 for mounting. In addition, this system allows for the grip cup to rotate within the connecting vessel 05. The grip cup 04 on the surface mount (main frame body apparatus) 01 becomes fixed in its position, but not its orientation inside the connecting vessel 05. In other words, the grip cup 04 and main apparatus 01 will remain mounted within the connecting vessel 05, but will be free to rotate within the connecting vessel 05 as necessary for a user.

The grip cup 04 can be used for mounting into a connecting vessel 05 in any form. Just using the grip cup 04 on various notebooks and tablet cases currently on the market is possible. The grip cup 04 alone can be mounted into the connecting vessel 05.

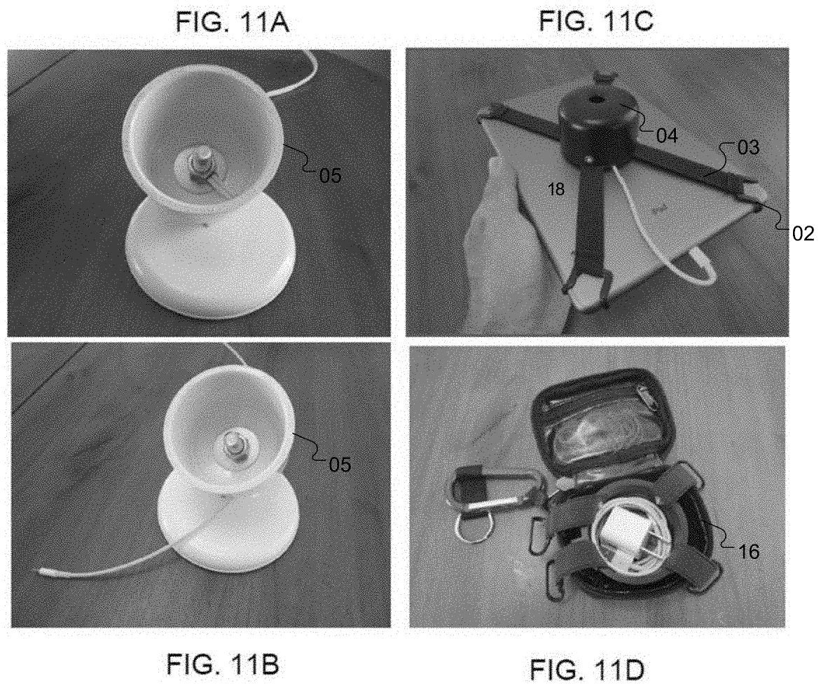

Referring to FIGS. 11C and 11D, there is opportunity to make this device portable for transportation by employing just the fitted slots 02, elastic webbing 03, or the grip cup 04 and not employing the connecting vessel 05, thereby making it easier to fold or tuck the elastic webbing 03 and pack in briefcases, backpacks, and tool kits. For example, referring to FIG. 11C, a tablet 18 can be portable by employing the elastic webbing 03, fitted slots 02, and the grip cup 04. In other embodiments, the system employs a connecting vessel 05 as illustrated by FIGS. 11A and 11B. Referring to FIG. 11D, a carrying case 16 can be utilized to carry the fitted slots 02, elastic webbing 03, and grip cup 04, along with other accessories such as ear buds, charging cable, and a ½″ to ¼″ adaptor that fits into the connecting aperture 06 for any third party mounting accessories such as a tripod or clamp. The system can therefore be compact and portable for easy transportation within the carrying case 16.

This system has many uses in fields such as medical, educational, and other industries that serve their customer base by using tablets, such as restaurant servers and rental car companies, to name just a fraction of the opportunities in other fields of technology with or without the charging feature. The use of a stylus is becoming more prominent thereby helping the ergonomics. Multitasking using a tablet, the ability to hold the tablet and securely mount it in one easy motion, charging the tablet without hunting for a power cord, ability to use voice commands, and saving battery life while providing a portability feature are all advantages that this system possesses.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

### LIST OF REFERENCE NUMBERS

01—surface mount (main frame body apparatus)
02—adjustable fitted slots for holding tablet (clips)
03—elastic webbing
04—grip cup
05—connecting vessel
06—connecting aperture
(hole) 07—threaded connector
08—installing apertures
09—wing nut
10—different color fitted slot for visual reference (clip)
11—charging cable from tablet (retractable)
12—charging cable to power source
14—base
16—carrying case
18—tablet

1. A mount for a tablet, the mount comprising:
a grip cup that is configured to be releasably attached to a vessel and is graspable by a hand of a user;
resilient straps attached to the grip cup; and
attachment members arranged at ends of the resilient straps, the attachment members being configured to releasably attach the resilient straps and the grip cup to the tablet.

2. The mount of claim 1, wherein the attachment members are configured to hold the tablet at corners of the tablet.

3. The mount of claim 1, wherein the grip cup is circular in shape.

4. The mount of claim 1, wherein the grip cup defines a connecting aperture, the aperture being located along a longitudinal axis of the grip cup.

5. The mount of claim 1, wherein the grip cup comprises plastic.

6. The mount of claim 1, wherein the attachment members are adjustable to accommodate different size tablets.

7. The mount of claim 1, wherein one of the attachment members is a different color than the other attachment members to indicate a proper orientation of the mount relative to the tablet.

8. A system for holding a tablet, the system comprising:
a mount comprising:
a grip cup that is configured to be releasably attached to a vessel and is graspable by a hand of a user;
resilient straps attached to the grip cup; and
attachment members arranged at ends of the resilient straps, the attachment members configured to releasably attach the resilient straps and the grip cup to the tablet; and
a connecting vessel configured to hold the mount.

9. The system of claim 8, wherein the connecting vessel is configured to hold the mount by the grip cup.

10. The system of claim 9, wherein the grip cup defines a connecting aperture, the aperture being located along a longitudinal axis of the grip cup.

11. The system of claim 10, wherein the connecting vessel comprises a threaded connector.

12. The system of claim 11, wherein the threaded connector is loose and pliable.

13. The system of claim 11, wherein the connecting aperture is inserted directly on to the threaded connector.

14. The system of claim 13, wherein the threaded connector acts as a locking mechanism.

15. The system of claim 14, further comprising a wing nut screwed onto the threaded connector to mount the grip cup to the connecting vessel in a locked position.

16. The system of claim 13, wherein the mount and the connecting vessel are configured so that the mount can be disconnected from the connecting vessel by pulling the grip cup along the longitudinal axis of the grip cup.

17. The system of claim 8, wherein the connecting vessel further comprises installing apertures.

18. The system of claim 8, wherein the attachment members are adjustable to accommodate different size tablets.

19. The system of claim 8, wherein the attachment members are configured to hold the tablet at corners of the tablet.

20. The system of claim 8, wherein the grip cup and the connecting vessel are circular in shape.
